(19) United States
(12) Patent Application Publication
(10) Pub. No.: US 2005/0213192 A1
(43) Pub. Date: Sep. 29, 2005

(54) Apparatus for modulating a light beam

(76) Inventors: Martin Edward Murtagh, County Cork (IE); Patrick Vincent Kelly, County Galway (IE)

Correspondence Address: JACOBSON HOLMAN PLLC, 400 SEVENTH STREET N.W., SUITE 600, WASHINGTON, DC, 20004, US

(21) Appl. No.: 11/135,269

(22) Filed: May 24, 2005

Related U.S. Application Data
(63) Continuation of application No. PCT/IE03/00158, filed on Nov. 27, 2003.

(30) Foreign Application Priority Data
Nov. 28, 2002 (IE) 2002/0913

(51) Int. Cl. G02F 1/29

(52) U.S. Cl. 359/298

(57) ABSTRACT

A modulation spectroscopy system (1) has an acousto-optic modulator (5) providing a pump beam onto a sample. The modulator receives a light beam from a source (4) and diffracts it to provide an output which is the first order beam, the zeroth order or undeflected beam being terminated and the 2nd and higher orders being negligible and terminated also. The modulator is driven alternately by two drive frequencies at a modulation or toggle frequency. The first order output is at one angle for a first drive frequency and at another angle for the other drive frequency. The duty cycle of alternating between the different drive frequencies sets the output beam position duty cycle for incidence at two different spots on the sample. Also, either or both beams may be position and/or intensity varied by control of the modulator drive frequencies and their amplitudes.

### FIELD OF THE INVENTION

The invention relates to modulation of light beams.

### PRIOR ART DISCUSSION

Modulation spectroscopy is a class of spectroscopy in which the reflectance (or transmission) of a material such as a semiconductor, an organic material, or a polymer is altered at some parts of the electromagnetic spectrum by means of an external perturbation. Generally, this perturbation is applied in a periodic manner, such that the reflectance (or transmission) of the semiconductor at the wavelengths where it changes in response to the external perturbation periodically alternates between the value in the absence of external perturbation and that which it has in the presence of the external perturbation. In many methods of modulation spectroscopy, the perturbation is optically applied by means of a light beam. In such methods, the light beam used to perform the spectroscopy measurement is often referred to as the “probe” beam and the light beam which perturbs the reflectance (or transmission) of the material is generally referred to as the “pump” beam. The pump beam is generally coincident with the probe beam on the sample and is generally modulated between being present and absent at the area of coincidence with the probe beam.

Modulated reflectance spectroscopy in which the application of a periodically modulated light beam directed on the material at the same point as the light beam used to perform reflectance spectroscopy, is commonly referred to as photoreflectance spectroscopy.

Conventional means used in modulating the pump beam in modulation spectroscopy all suffer from disadvantages. Mechanical chopping of the beam suffers from limitations to the stability of the frequency of chopping, limitations to the speed (modulation frequency) of chopping which is possible, and produces a periodic intensity profile which departs from an ideal square wave or sinusoidal wave intensity variation with time.

Electronic modulation of the pump source depends on the response characteristics of the optical source light output to the electrical power provided, and may produce a periodic intensity profile which departs from an ideal square wave or sinusoidal wave intensity variation with time. U.S. Pat. No. 5,255,071 describes a method of photoreflectance spectroscopy in which the modulation of the probe light beam is performed by a method of acousto-optic modulation which modulates the pump beam with a desired on/off frequency. Such modulation involves switching off the light beam for each half cycle at a modulation frequency. This frequency can be high for some applications, and for high frequencies it appears that the level of light output extinction for these half cycles may not be as good as is desirable. Also, at high modulation frequencies the switching time can become significant with respect to the duty cycle off period. Another possible problem is that in the off state there may be residual optical beam scatter.

It is known to use scanning mirrors to vary the position of incidence of a beam on a sample, the variation being periodic at a modulation frequency. However, they suffer from being limited to low frequencies (typically much lower than 3 kHz), are confined to small scan angles (typically much less than 1 mrad in the region of 0.5 kHz frequency), and may suffer from backlash, vibration, and overshoot problems.

Methods of modulation spectroscopy in which the pump beam is deflected continuously, or swept across the sample surface on and off the area of incidence of the probe beam, suffer from the disadvantage that the pump beam may only be swept by precisely its own diameter in order to achieve the optimum 50% duty cycle of modulated pumping of the probe beam area of incidence on the sample. Such an arrangement is inherently difficult to practically engineer, only achieves zero intensity at one extreme of the pump beam sweep cycle, and is prone to failing to achieve that zero intensity unless exacting optical and mechanical engineering tolerances are met in practice. Another problem is that there is little versatility allowed in operating parameters such as beam intensity and modulation frequency.

The invention addresses these problems.

### SUMMARY OF TE INVENTION

According to the invention, there is provided a light beam modulator comprising means for modulating a source beam to provide an output beam at any one time on one of a plurality of discrete paths according to a modulation scheme.

In one embodiment, the modulator operates such that an output beam is always directed onto one of the paths, or in which during switching between said paths a beam is absent from both paths for no longer than a time which is short compared to a characteristic response time of a detector of the output beams.

In another embodiment, the paths are deflected from the direction of the source beam or undeflected (zeroth order) beam.

In a further embodiment, the output beams comprises first order diffracted light from the source beam.

In one embodiment, the modulator comprises an acousto-optic crystal and a drive circuit which switches between different drive frequencies at a modulation or toggle frequency.

In another embodiment, the drive circuit provides a drive frequency change duty cycle corresponding to a desired beam output duty cycle for switching between the paths.

In a further embodiment, the modulator comprises means for setting the degree of deflection of one or all of the discrete paths.

In one embodiment, the modulator comprises means for setting the degree of deflection according to an applied drive signal frequency for the crystal.

In another embodiment, the modulator further comprises means for controlling intensity of the output beam on one or both paths.

In a further embodiment, the modulator comprises an acousto-optic crystal and drive circuit and the drive circuit comprises control means for changing amplitude of the applied driver signal frequency for the relevant path or paths.

In one embodiment, the modulator further comprises a position feedback loop comprising an output beam spot detector connected to a modulator drive means for changing path of a beam according to feedback from the detector.

In another embodiment, the detector is a position sensitive detector comprising a quadrant photodiode operated in differential mode.

In a further embodiment, the modulator further comprises an intensity feedback loop comprising an output beam intensity detector connected to a modulator drive means for changing intensity of one or both beams according to feedback.

In one embodiment, the intensity detector comprises a quadrant photodiode operated in summation mode.

In another embodiment, the modulator comprises means for terminating a residual part of the source beam.

In a further embodiment, the residual part is an order other than the first order.

In one embodiment, the modulator provides the zero order output in a default mode without drive power and said order is terminated.

In another embodiment, the modulator comprises a programmably electro-mechanically, electro-optically, or piezoelectrically variable diffractive optic element for switching the output beam between the paths.

In a further embodiment, the modulator comprises means for switchably rotating the plane of polarisation of a linearly polarised pump beam, and routing means for causing the beam to traverse a different spatial path for each polarisation.

In one embodiment, the rotating means comprises a Pockels Cell controlled by a drive voltage.

In another embodiment, the rotating means comprises a spatial light modulator controlled by a drive voltage.

In a further embodiment, the rotating means comprises a liquid crystal spatial light modulator.

In one embodiment, the rotating means comprises a ferroelectric spatial light modulator.

In another embodiment, the rotating means comprises a Wollaston Prism.

In a further embodiment, the rotating means comprises a polarising beam splitter.

In a further aspect there is provided a modulation spectroscopy system comprising a modulator as defined above.

In a further embodiment there is provided a laser blocking system comprising a modulator as defined above and a means for safety terminating a zero order output, and an interlock mechanism connected to shut power from the modulator (acousto-optic) if an unsafe event occurs, causing only the zeroth order to be output and safely terminated.

### DETAILED DESCRIPTION OF THE INVENTION

### BRIEF DESCRIPTION OF THE DRAWINGS

The invention will be more clearly understood from the following description of some embodiments of the apparatus thereof, given by way of example only with reference to the accompanying drawings in which:—

FIG. 1 shows an inspection system incorporating a modulator of the invention and being for modulation spectroscopy;

FIG. 2 shows operation of the modulator of the system of FIG. 1 in more detail; and

FIGS. 3, 4 and 5 are diagrams showing alternative modulators of the invention.

### DESCRIPTION OF THE EMBODIMENTS

The invention provides an apparatus and method for modulating a light beam, which may be used for various purposes including that of inducing a modulation of the optical and/or electronic properties of a target material by an optical means.

Components of the system of the invention are those which produce, and perform the modulation of, a light beam incident on a sample material, as follows. In this specification, optical coupling may use free space components, or suitable waveguides.

A light source, called the pump light source, produces a light beam having a single wavelength or a narrow spectrum of wavelengths, and optical components for shaping the light beam and coupling it to other components of the system. A pump beam optical intensity modulator between the pump light source and the sample modulates the intensity of the light steered to the point of incidence of the pump beam on the sample by alternating the position of incidence of the pump beam on the sample from a position coincident with the point of incidence of the probe beam on the sample, to a position in which the pump and probe beam areas of incidence do not wholly or partially coincide. This is achieved without sweeping the beam across from one position to the other, but instead by alternately directing the output beam onto one of two discrete paths. The output is at any one time on one path or the other path.

Where the modulation system forms part of a larger system, such as those used in many types of modulation spectroscopy, including modulated photoluminescence spectroscopy, modulated reflectance spectroscopy, modulation transmission (absorption) spectrometry, modulation fluorescence spectrometry, or modulated surface photovoltage measurements, the wavelength of the pump light source is chosen such that the corresponding photon energy is greater than that of the bandgap of a semiconductor to be inspected, or is greater than the separation of two molecular electronic energy levels of a chemical substance to be inspected, or is otherwise sufficient in photon energy to cause the creation of photo-induced charge carrier in the material to be inspected.

In one embodiment, the sample is horizontally mounted, and the sample mounting subsystem has a means for moving the sample vertically up and down to place its surface corresponding to the optimum alignment of the light beam from the input probe beam subsystem to the output probe beam subsystem by reflection from the sample surface.

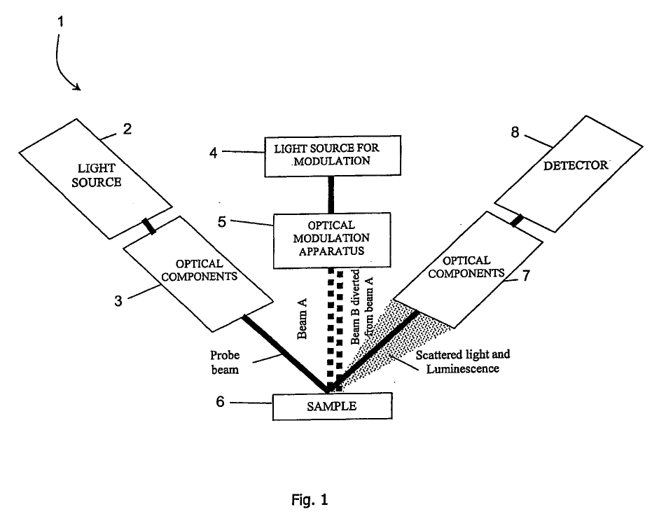

Referring to FIG. 1 a modulation spectroscopy system 1 comprises the following.
2: A probe light source subsystem which produces a light beam having a broad spectrum of wavelengths, and optical components for shaping this light beam and coupling it to other components together with mechanical mounts.
3: A monochromator subsystem for dispersing the wavelengths of light from 2 such that only a narrow range of wavelengths of the light are selected and transmitted. The subsystem 3 comprises optical beamsteering components for shaping the probe light beam, steering it, and coupling it to a sample material.
4 & 5: A pump beam source and modulator, described in more detail below.
6: A sample mounting subsystem which holds a sample material, but may also move the sample relative to light beams.
7: An output optical subsystem for coupling (collecting) a light beam reflected or scattered from a sample material, shaping the light beam, and coupling it to other components.
8: A detector subsystem, which may form part of the output beam optical subsystem for detecting light reflected and/or scattered.

A mechanical assembly to which some or all of the subsystems are mounted, such that the optical beamsteering subsystem 3 and the output probe beam subsystem 7 are mounted with their optical axes such that the light beam from the input probe beam subsystem is reflected from the sample into the optical path of the output probe beam subsystem 7.

An electronic subsystem for recording an electrical signal from said detector 8, and for the distinction of periodic electrical signals of different frequencies from each other and from a time-invariant electrical signal, and for the selective detection of electrical signals of certain desired frequencies.

A computer subsystem for control of the several subsystems, and an electrical power subsystem provides mains and low voltage electrical power.

In some embodiments there may be an additional optical beamsteering subsystem for collecting luminescence and scattered light emitted by the sample material, shaping this light into a light beam, and coupling it to other components.

The pump beam subsystem is mounted such that the pump beam is incident at the same position on the sample as the probe beam. For any angle of incidence of the probe beam on the sample which can be achieved using the mechanical assembly, it at least fully covers the probe beam spot area on the sample. The pump beam subsystem 5 may be mounted such that the angle of incidence of the pump beam is normal to the sample surface, or is at some other angle of incidence to allow other subsystems to be incorporated.

In a larger system in which a luminescence and scattered light detector is incorporated, the detector may be placed so that it collects light from the region of incidence of the pump beam on the sample when it is coincident with the probe beam, and from the region of incidence of the pump beam on the sample to which it is diverted by the modulation means, with approximately equal efficiency of detection of luminescence and scattered light from either position.

The sample may be horizontally mounted, and the sample mounting subsystem has a means for moving the sample vertically up and down to place its surface corresponding to the optimum alignment of the light beam from the input probe beam subsystem to the output probe beam subsystem by reflection from the sample surface.

The modulator 5 produces a synchronously alternating spatial modulation of a light beam, with extinction of the light beam when in its off state in either spatial position, and with control of the duty cycle so that the duty cycle can be precisely 50% in each spatial position, or any other ratio of time in each position. The modulator provides the additional advantage that the duration for which the light is extinguished momentarily at both positions during switching, can be rendered negligible compared to the response time of typical optical detectors and detection electronics, so that switching transient effects can be eliminated. The modulator 5 of the system also allows the intensity of the light in the on state in either spatial position to be varied. The intensity variation is possible for a single path or for both paths. Also, the angle of one or both paths can be easily changed with control of rf drive frequency signals to the modulator, thus allowing simple adjustment of the position of impingement of the pump beam on the sample.

The invention can be applied to synchronously alternating modulation reflectance spectroscopy, where it is of particular advantage in elimination of undesirable luminescence signals from the desired modulated reflectance signal. Both of these signals can appear as an a.c. signal in the detector at the same modulation frequency, and the luminescence component must be rendered as a d.c. signal to eliminate it, by employing phase sensitive lock-in amplifier electronic detection. Such applications can isolate the modulated reflectance signal and improve the signal to noise ratio in modulation spectroscopy.

The modulator 5 comprises an acoustic-optical modulator device that operates by producing a strong first order optical beam, deflected at an angle from the incident beam path, when a driver signal at radio frequencies (10-500 MHz is typical) is applied.

Within the device, an acoustic signal capable of causing the crystal to transmit light in a diffracted first-order beam as well as a residual zeroth order beam by means of the acousto-optic effect. When the driver signal is turned off, all of the light beam intensity incident on the crystal passes straight through in the zeroth order. When the driver signal is turned on, most (typically between 85% and 90%) of the light beam incident on the crystal is diffracted into a first order beam making an angle with the path of the zeroth order beam, but the remainder (typically between 10% and 15%) passes straight through in zero order as when the signal is off. Thus in summary, the acoustic optic modulator device drive is modulated between a frequency at which the first order light is at one angle and another drive frequency at which the first order light is at a different angle. These are the two discrete beam paths referred to above. The straight-through zero order beam is not used, and may be terminated.

In this system the first order light beam is used, its angle being modulated. There is also as set out above a zero order which is dumped (terminated). There may also be 2^{nd} and higher orders, however, the intensity is typically much less. These orders may be ignored if their intensity is very low, or otherwise they may be terminated. It is envisaged that in some circumstances the 2^{nd} or higher orders may be used instead of the 1^{st} order. The beam termination of the zero order provides an important safety feature. An interlock mechanism directly shuts power from the modulator crystal if a cover or other safety barrier is opened or moved. This causes all diffracted orders (1^{st}, 2^{nd}, etc.) to cease, leaving only the zero order, which is safely terminated. The interlock mechanism is thus fail-safe.

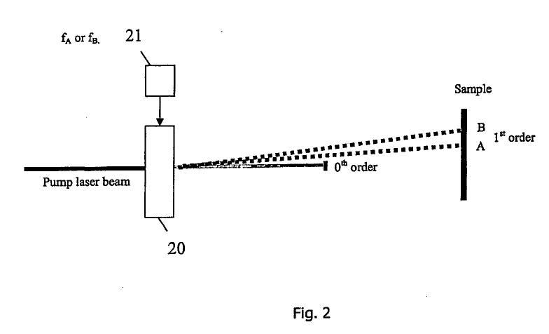

The system 1 has a programmably variable drive frequency to modulate the pump beam in two alternately modulated discrete paths. FIG. 2 shows the modulator in more detail.

The acoustic-optic modulator is indicated by the numeral 20, and it is driven by a drive circuit 21. The first order beam, diverted by the action of the acousto-optic modulator 20 is caused to appear alternately at two different positions on the sample, and the residual zeroth order beam is simply dumped into a beam block and is not incident on the sample material.

The method works by using the first order diffracted beam (but may alternatively use higher order diffracted beams), and by making use of the fact that the angle of deflection of the first order beam from the zeroth order beam is a function of the applied driver frequency. By applying either one of a pair of sufficiently different driver frequencies f_{A} and f_{B}, alternately, the first order beam may itself be deflected from one angular trajectory to another, such that its point of incidence may be changed from one position A on a sample to another position B on the sample, within a very short period of time determined by the response of the acousto-optic modulator to an abrupt change in driver frequency from f_{A} to f_{B}. The duty cycle may be fully controlled by simply controlling the timing of operation of the drive circuits at each drive frequency. The switching of the acousto-optic modulator driver frequency from f_{A} to f_{B} may be accomplished by means of a much lower frequency modulation signal applied to the driver source using suitable electronic and control devices and circuitry. It is important to note that the rf drive power is always on with one or other drive rf frequency, and that the problems of the single beam prior art with poor extinction due to residual rf power when the rf power is in the off portion of its duty cycle, are eliminated. This is a particular advantage of the invention.

An appropriate optical lensing system can be used to constrict the pump beam which transverses the acousto-optic modulator device such that the switching time between both beam positions is further reduced.

In general, the modulator operating parameters are as follows:
rf drive frequency of the acousto-optic modulator crystal, of the order of 100's MHz.
The frequency at which the beam is switched between the two discrete paths, namely the modulation or toggle frequency. This is typically in the range of hundreds of Hz to low MHz for modulation spectroscopy applications.

The angle between the two discrete paths (and thus the spatial separation on the sample) may be varied by varying one or both of the drive frequencies. Also, changing of both drive frequencies can be performed to achieve an equal shift of both beams with no mutual angle difference. Also, intensity of either or both beams may be varied by changing the amplitude of one or both of the drive frequencies. Furthermore, the duty cycle may be varied from 50:50 to any desired ratio by changing the modulation or toggling duty cycle.

The use of a programmable controller for the acousto-optic modulator allows the intensity of the pump beam to be controlled at one or both locations with particular ease and versatility. A photosensitive detector positioned to detect all or part of the pump beam reflected from the sample can form part of a feedback device of an intensity control mechanism. Such an intensity control mechanism can be used in modulation spectroscopy applications to vary the intensity of the modulated pump laser beam. The use of such a laser intensity feedback loop ensures the stability of the intensity of the laser spot in each of its two spatial positions of incidence on the sample. Beam spot position feedback may be performed to vary the beam positions on the sample (by drive frequency control as set out above). In particular, the spot position may be detected by a position sensitive detector (PSD) of the type having a quadrant photodiode. A PSD may be used also for intensity detection for intensity feedback. For position detection the PSD is operated in a differential mode, and for intensity feedback it is operated in a summation mode.

The following describes the acousto-optic modulator in more detail. The acousto-optic modulator is a Bragg diffraction device consisting of a tellurium dioxide crystal (acousto-optic medium), with lithium niobate piezoelectric transducers used to generate the rf frequency. The rf centre frequency of operation is 200 MHz, with an active aperture height of 0.5 mm and a multilayer dielectric anti-reflection coating optimised for the optical design wavelength of 532 nm. The frequency shift range for the particular device employed is ±150 MHz to 250 MHz, and with a rise time determined to be 151D [nsecs], for a beam diameter, D [mm]. The modulator frequency response is characterised by the depth of modulation (M) or modulation index, as calculated by: M=exp(−6.8×10⁻²D²fₘ²), with fₘ the modulation (drive) frequency [MHz]. The angular position of the first order beam is proportional to the acoustic frequency, with the angular deviation given by: Δθ=λΔF/V, with λ the laser wavelength (532 nm), ΔF the drive frequency change and V the acoustic velocity (4.26 mm/psec). Total deviation is limited by the transducer electrical bandwidth. For the acoustic-optic modulator unit employed, a typical frequency deviation of 100 MHz centred at 200 MHz will deflect the 532 nm light through an angle of 12.4 milliradians centred 25 milliradians from the undeflected beam (straight through or zeroth order beam datum). The system employs the higher intensity 1^{st} order diffracted light beam, with the percentage of light in the first order given by: sin²(2.22[1/λ²(L/H)M₂Pₐ]^{1/2}), with Pₐ the acoustic power, M₂ the material figure of merit and L/H the sound field length to height aspect ratio.

The modulator is controlled by a PC interface control card which controls the rf drive frequencies and amplitude, as well as rf drive frequency switching or toggling frequency. The PC card output provides control to the rf amplifier and thence to the acousto-optic crystal, all connected via. screened 50 ohm co-axial cabling. The control card further provides a switching or toggle frequency output terminal—for use as the reference lock-in amplifier channel, as well as an interlock connection, immediately disengaging the drive power to the acousto-optic crystal when activated (failsafe).

In detail, the particular scheme consists of two beam operation—deflection mode acousto-optic modulation, using two (variable) rf drive frequencies to firstly produce two separate and distinct beams (1′ diffraction order) at the sample surface, but also to control both the sample spot locations (tandem movement) as well as the separate movement of one beam with respect to the other.

Before system alignment, the incidence angle between the modulator and the incident pump (laser) beam is firstly adjusted by rotating the acousto-optic crystal, until maximum intensity is achieved in either diffracted (1^{st} order) beams.

System alignment for double beam switching then requires both beam spot movement—tandem &/or separately, in order to establish fully symmetric, optical collection for both pump beam induced luminescence background signals. System (modulation spectroscopy) operation also consists of repeat alignment (if required by a particular sample), but also for the case of unequal or non-uniform sample luminescence signal yields, relative beam intensity changes to ensure equal (dc signal) background luminescence. This is achieved firstly by blocking or switching off the probe beam, then adjusting the relative beam locations on sample (after initial tandem beam alignment), followed by relative beam intensity variation until attaining zero or minimum background signal level as measured from the detector and electronics (lock-in amplifier output).

Note that it is required whenever changing the drive frequencies, or relative drive frequency between beams, to also adjust the relative beam throughput or drive frequency amplitude, on account of small changes in the diffraction efficiency and thus beam intensity with drive frequency.

As well as direct PC operation/control, both beam modulation position and intensity control is also automated via pump beam intensity feedback in the full spectroscopy system, i.e. measuring both diffracted beams output via separate and dedicated pump beam photo-sensitive detectors (photo-diode). It is noted that such pump beam photo-detectors consist of position sensitive detectors—quadrant photo-diodes, to provide feedback for both positional control in the system (differential operation mode) as well as intensity feedback control (operating in summing mode).

Finally the zeroth and any other unwanted diffraction orders are spatially filtered in the system with an optical beam dump, forming the total beam stop when the interlock connection is activated—discontinued rf drive power to the acoustic-optic crystal and thus no diffraction light beams (it order etc.) from the undetected straight through beam.

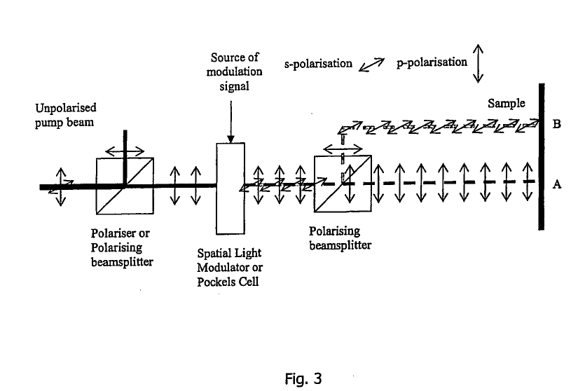

FIG. 3 shows an alternative embodiment of the invention. The modulating component may be either a liquid crystal, or ferroelectric, or other type of spatial light modulator, or else may be a Pockels cell or other type of polarisation rotating or switching component, the function of any of which is to switchably rotate the plane of polarisation of the polarised pump beam through an angle of 90°. The beam subsequently passes into a polarising beamsplitter, which transmits one polarisation, and reflects the other orthogonal polarisation, which is steered to an adjacent position of incidence on the sample by means of a beam steering mirror. The pump beam is switched between these positions of incidence by means of the polarisation switching device. This has the advantage that almost the entire beam intensity after the polariser is directed to one or other of the desired points of incidence.

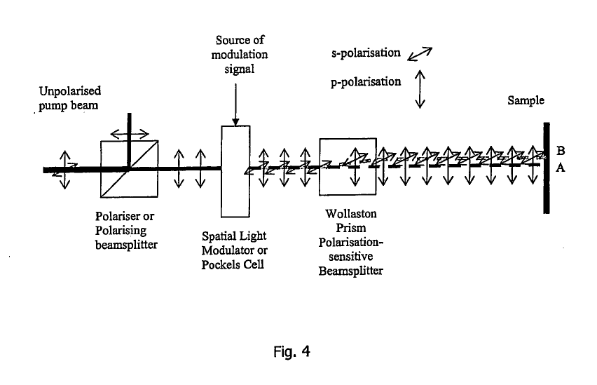

FIG. 4 shows an embodiment in which the modulating component may be either a liquid crystal, or ferroelectric, or other type of spatial light modulator, or else may be a Pockels cell, the function of any of which is to switchably rotate the plane of polarisation of the polarised pump beam through an angle of 90°. The beam subsequently passes into a Wollaston prism, which transmits both polarisations in the forward direction, but spatially separated in adjacent beam paths, so that each polarisation is incident at a different position on the sample. The pump beam is switched between these positions of incidence by means of the polarisation switching device.

In the systems of FIGS. 3 and 4, the source of the light beam to be modulated requires to be polarised in a particular orientation relative to one of the principal axes of the apparatus for the most efficient implementation of the method. Where the source is monochromatic, such as a laser, and already has a dominant polarisation, this polarisation may be rotated into the desired orientation by means of a half-wave plate, being an optically polished plate of a birefringent optically transmitting material suitably oriented such that its thickness corresponds to an integral number of wavelengths plus one-half wavelength of said source of light, and rotated to a suitable orientation to cause the polarisation plane to be rotated by means of relative retardance of the ordinary and extra-ordinary rays in the birefringent material into the desired orientation relative to the modulation apparatus. Where the source is polychromatic, a double Fresnel rhomb or a Babinet compensator or other half wave retarder having similar effect over a wide range of wavelengths may be substituted for the half-wave plate.

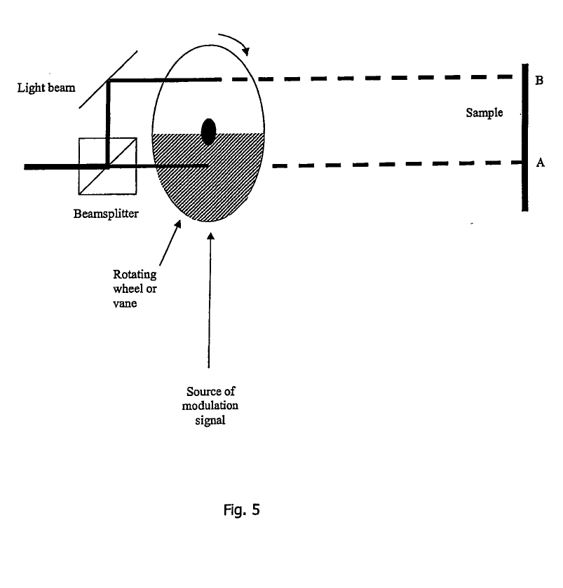

Referring to FIG. 5 a modulator receives a single beam, and has a beam splitter which splits the beam into two paths. A rotating mechanical chopper with appropriate slits causes by virtue of its rotation one or other beam to impinge on the sample. A polariser and Wollaston beamsplitter combination may alternatively be used to spatially split the light beam into a pair of light beams. The frequency is that at which the mechanical chopper rotates. The pair of light beams must be oriented relative to the rotating chopper such that when one light beam passes through a transparent part, the other light beam is blocked by an opaque part of the vane or wheel, and vice versa. The duty cycle can be controlled by changing the transparent/opaque wheel (vane) pattern or ratio on the chopper.

The systems described above provide single modulation, in that only one beam (the pump beam) is modulated, although it may be caused to appear in one or other of two spatial positions.

The invention finds application in the following technical fields, among others wherever background (unwanted) signals exist at the same modulation frequency as the desired signal.
Methods and apparatus for modulated reflectance spectroscopy.
Methods and apparatus for modulated reflectance measurement using a single wavelength probe beam.
Modulated luminescence spectroscopy, such as photoluminescence.
Photothermal modulation of any property of a material, or measurement methods and/or photothermal modulation of any property of a material.
Photoelectronic modulation of any property of a material, or measurement based on photoelectronic modulation of any property of a material.
Methods and apparatus for modulated surface photovoltage measurements.
Methods and apparatus for modulated surface photovoltage spectroscopy.
Methods and apparatus for modulated optical transmission or absorption spectroscopy.
Methods and apparatus for modulated optical transmission or absorption measurements.

It will be appreciated that the invention provides for improved modulation of a light beam. It allows the production of a synchronously alternating spatial modulation of a light beam, with extinction of the light beam when in its off state in either spatial position, and with control of the duty cycle so that the duty cycle can be precisely 50% in each spatial position, or any other ratio of time in each position. Another major advantage is that the beam positions can be controlled individually or in tandem in some embodiments. Also, in some embodiments, the beam intensities can be controlled separately or in tandem. The modulation of the invention may be used in modulation spectroscopy, or other applications as set out above.

The invention is not limited to the embodiments described but may be varied in construction and detail. For example, the modulator may be incorporated into a single integrated circuit. The modulator may alternatively comprise a Mach-Zehnder interferometer. Also, the means for rotating the plane of polarisation may comprise a spatial light modulator, such as the liquid crystal or ferroelectric types. The polarised beams may be routed by a Wollaston Prism or by a polarising beam splitter. Also, the spatial modulation of a laser beam may be used in conjunction with one or more beam dumps in order to interlock the operation of a laser with one or more other equipment conditions for the purposes of laser safety.

1. A light beam modulator comprising means for modulating a source beam to provide an output beam at any one time on one of a plurality of discrete paths according to a modulation scheme.

2. A light beam modulator as claimed in claim 1, wherein the modulator operates such that an output beam is always directed onto one of the paths, in which during switching between said paths a beam is absent from both paths for no longer than a time which is short compared to a characteristic response time of a detector of the output beams.

3. A light beam modulator as claimed in claim 1, wherein the paths are deflected from the direction of the source beam or undeflected (zeroth order) beam.

4. A light beam modulator as claimed in claim 1, wherein the output beam comprises first order diffracted light from the source beam.

5. A light beam modulator as claimed in claim 1, wherein the output beam comprises first order diffracted light from the source beam; and wherein the modulator comprises an acousto-optic crystal and a drive circuit which switches between different drive frequencies at a modulation or toggle frequency.

6. A light beam modulator as claimed in claim 1, wherein the output beam comprises first order diffracted light from the source beam; and wherein the modulator comprises an acousto-optic crystal and a drive circuit which switches between different drive frequencies at a modulation or toggle frequency; and wherein the drive circuit provides a drive frequency change duty cycle corresponding to a desired beam output duty cycle for switching between the paths.

7. A light beam modulator as claimed in claim 1, wherein the output beam comprises first order diffracted light from the source beam; and wherein the modulator comprises means for setting the degree of deflection of one or all of the discrete paths.

8. A light beam modulator as claimed in claim 1, wherein the output beam comprises first order diffracted light from the source beam; and wherein the modulator comprises means for setting the degree of deflection of one or all of the discrete paths; and wherein the modulator comprises means for setting the degree of deflection according to an applied drive signal frequency for the crystal.

9. A light beam modulator as claimed in claim 1, further comprising means for controlling intensity of the output beam on one or both paths.

10. A light beam modulator as claimed in claim 1, further comprising means for controlling intensity of the output beam on one or both paths; and wherein the modulator comprises an acousto-optic crystal and drive circuit and the drive circuit comprises control means for changing amplitude of the applied driver signal frequency for the relevant path or paths.

11. A light beam modulator as claimed in claim 1, wherein the output beam comprises first order diffracted light from the source beam; and wherein the modulator further comprises a position feedback loop comprising an output beam spot detector connected to a modulator drive means for changing path of a beam according to feedback from the detector.

12. A light beam modulator as claimed in claim 1, wherein the output beam comprises first order diffracted light from the source beam; and wherein the modulator further comprises a position feedback loop comprising an output beam spot detector connected to a modulator drive means for changing path of a beam according to feedback from the detector; and wherein the detector is a position sensitive detector comprising a quadrant photodiode operated in differential mode.

13. A light beam modulator as claimed in claim 1, wherein the output beam comprises first order diffracted light from the source beam; and wherein the modulator further comprises an intensity feedback loop comprising an output beam intensity detector connected to a modulator drive means for changing intensity of one or both beams according to feedback.

14. A light beam modulator as claimed in claim 1, wherein the output beam comprises first order diffracted light from the source beam; and wherein the modulator further comprises an intensity feedback loop comprising an output beam intensity detector connected to a modulator drive means for changing intensity of one or both beams according to feedback; and wherein the intensity detector comprises a quadrant photodiode operated in summation mode.

15. A light beam modulator as claimed in claim 1, wherein the output beam comprises first order diffracted light from the source beam; and wherein the modulator comprises means for terminating a residual part of the source beam.

16. A light beam modulator as claimed in claim 1, wherein the output beam comprises first order diffracted light from the source beam; and wherein the modulator comprises means for terminating a residual part of the source beam; and wherein the residual part is an order other than the first order.

17. A light beam modulator as claimed in claim 1, wherein the output beam comprises first order diffracted light from the source beam; and wherein the modulator comprises means for terminating a residual part of the source beam; and wherein the residual part is an order other than the first order; and wherein the modulator provides the zero order output in a default mode without drive power and said order is terminated.

18. A light beam modulator as claimed in claim 1, wherein the modulator comprises a programmably electro-mechanically, electro-optically, or piezoelectrically variable diffractive optic element for switching the output beam between the paths.

19. A light beam modulator as claimed in claim 1, wherein the modulator comprises a programmably electro-mechanically, electro-optically, or piezoelectrically variable diffractive optic element for switching the output beam between the paths; and wherein the modulator comprises means for switchably rotating the plane of polarisation of a linearly polarised pump beam, and routing means for causing the beam to traverse a different spatial path for each polarisation.

20. A light beam modulator as claimed in 1, wherein the modulator comprises a programmably electro-mechanically, electro-optically, or piezoelectrically variable diffractive optic element for switching the output beam between the paths; and wherein the modulator comprises means for switchably rotating the plane of polarisation of a linearly polarised pump beam, and routing means for causing the beam to traverse a different spatial path for each polarisation; and wherein the rotating means comprises a Pockels Cell controlled by a drive voltage.

21. A light beam modulator as claimed in claim 1, wherein the modulator comprises a programmably electro-mechanically, electro-optically, or piezoelectrically variable diffractive optic element for switching the output beam between the paths; and wherein the modulator comprises means for switchably rotating the plane of polarisation of a linearly polarised pump beam, and routing means for causing the beam to traverse a different spatial path for each polarisation; and wherein the rotating means comprises a spatial light modulator controlled by a drive voltage.

22. A light beam modulator as claimed in claim 1, wherein the modulator comprises a programmably electro-mechanically, electro-optically, or piezoelectrically variable diffractive optic element for switching the output beam between the paths; and wherein the modulator comprises means for switchably rotating the plane of polarisation of a linearly polarised pump beam, and routing means for causing the beam to traverse a different spatial path for each polarisation; and wherein the rotating means comprises a spatial light modulator controlled by a drive voltage; and wherein the rotating means comprises a liquid crystal spatial light modulator.

23. A light beam modulator as claimed in claim 1, wherein the modulator comprises a programmably electro-mechanically, electro-optically, or piezoelectrically variable diffractive optic element for switching the output beam between the paths; and wherein the modulator comprises means for switchably rotating the plane of polarisation of a linearly polarised pump beam, and routing means for causing the beam to traverse a different spatial path for each polarisation; and wherein the rotating means comprises a spatial light modulator controlled by a drive voltage; and wherein the rotating means comprises a ferroelectric spatial light modulator.

24. A light beam modulator as claimed in claim 1, wherein the modulator comprises a programmably electro-mechanically, electro-optically, or piezoelectrically variable diffractive optic element for switching the output beam between the paths; and wherein the modulator comprises means for switchably rotating the plane of polarisation of a linearly polarised pump beam, and routing means for causing the beam to traverse a different spatial path for each polarisation; and wherein the rotating means comprises a Wollaston Prism.

25. A light beam modulator as claimed in claim 1, wherein the modulator comprises a programmably electro-mechanically, electro-optically, or piezoelectrically variable diffractive optic element for switching the output beam between the paths; and wherein the modulator comprises means for switchably rotating the plane of polarisation of a linearly polarised pump beam, and routing means for causing the beam to traverse a different spatial path for each polarisation; and wherein the rotating means comprises a polarising beam splitter.

26. A modulation spectroscopy system comprising a modulator as claimed in claim 1.

27. A laser blocking system comprising a modulator as claimed in claim 1 and a means for safely terminating a zero order output, and an interlock mechanism connected to shut power from the modulator (acousto-optic) if an unsafe event occurs, causing only the zeroth order to be output and safely terminated.
